(19) United States
(12) Patent Application Publication
(10) Pub. No.: US 2015/0015405 A1
(43) Pub. Date: Jan. 15, 2015

(54) WARNING DEVICE FOR MONITORING A HEALTH STATUS OF A BEARING MOUNTED TO A PIECE OF ROTATING INDUSTRIAL MACHINERY

(71) Applicant: Aktiebolaget SKF, Goteborg (SE)

(72) Inventors: Torsten Bark, San Diego, CA (US); Jonathan David Murphy, Friday Harbor, WA (US)

(21) Appl. No.: 14/366,535

(22) PCT Filed: Nov. 30, 2012
(86) PCT No.: PCT/US2012/067293

§ 371 Date: Jun. 18, 2014

Related U.S. Application Data
(60) Provisional application No. 61/577,884, filed on Dec. 20, 2011.

(51) Int. Cl. G08B 21/18; G01M 13/04; F16C 41/00

(52) U.S. Cl. CPC G08B 21/187; F16C 41/008; G01M 13/04
USPC 340/682

(57) ABSTRACT

A warning device and for monitoring a health status of a bearing mounted to a piece of rotating machinery is provided. The warning device includes a generally cylindrical body portion, an annular top portion, a base portion, and a battery for powering the device. The device has at least one sensor that senses one of a velocity, an enveloped acceleration and a temperature value of the bearing and at least one light emitting diode that displays the health status of the bearing according to input from one of the sensors. A mounting pad integral to the base portion allows the warning device to be mounted to rotating industrial machinery. A circuit board is disposed within the body and at least one thermally conductive circuit board trace is integrally disposed within the mounting pad. The trace conducts heat from the mounting pad to one of the at least one sensors.

### FIELD OF THE INVENTION

The present disclosure generally relates to a device for monitoring a health status of a bearing mounted to a piece of rotating industrial machinery. More particularly, the present disclosure relates to a warning device permanently mounted to a piece of rotating industrial machinery having sensors that detect changes in temperature, acceleration and velocity and displaying those changes when they reach an alarmed condition.

### BACKGROUND OF THE INVENTION

The present invention provides a simple, low cost way to monitor the status of a bearings health in a piece of rotating industrial equipment. Historically simple transmitter based systems have been employed on industrial machinery for overall machine health and detection of bearing degradation. These devices measure continuously and can be connected to existing control systems (PLC or DCS). The simplest approach is a 420 VT Vibration Transmitter. This loop-powered device measures Velocity (and can include Temperature) and has an End-User price of about $400.00. Also, a major consideration is the installation cost, especially for cabling.

The present invention provides a low cost battery powered device that enables multi-parameter measurements. One that is packaged into a compact unit and requires no setup or configuration. LED's simplify the read out logic and the battery is designed for long life.

### SUMMARY OF THE INVENTION

The basic inventive concept provides a warning device for monitoring a health status of a bearing mounted to a piece of rotating machinery in an industrial environment. A first aspect of the present invention provides a warning device for monitoring a health status of a bearing mounted to a piece of rotating machinery in an industrial environment, the warning device having:

a generally cylindrical body portion;

an annular top portion;

a base portion;

a battery for powering the device;

at least one sensor that senses at least one of a velocity, an enveloped acceleration and a temperature value of the bearing;

at least one tri-color light emitting diode for displaying the health status of one of the at least one sensors;

a magnetic key to be applied to the device that activates the device;

a mounting pad integral to the base portion for mounting the warning device to the piece of rotating industrial machinery;

a circuit board disposed within the body; and

at least one thermally conductive circuit board trace integrally disposed within the mounting pad, the trace to conduct heat from the mounting pad to one of the at least one sensors, and wherein

the one of the at least one sensors being mounted on the circuit board; and wherein

the device initiates a self check mode to verify its proper function after the magnetic key is applied.

In a second aspect of the present invention the at least one sensor further provides two temperature sensors and an acceleration sensor.

In a third aspect of the present invention the mounting pad is hexagonal in shape and has at least two flat surfaces for tightening the warning device with a tool.

In another aspect of the present invention a battery provides power to the device for at least 3 years of normal operation with a single alarm detection.

In another aspect of the present invention the at least one tri-color light emitting diode is mounted on an upper top surface of the warning device for maximum visibility to a user.

In another aspect of the present invention one of the at least one tri-color light emitting diode illuminates green when the device passes its self check mode.

In another aspect of the present invention one of the at least one light emitting diodes illuminates amber when the device fails the self check mode.

In another aspect of the present invention the device wakes up a predetermined number of times over a 24 hour period in order to check if the industrial machine is in operation.

In another aspect of the present invention after waking up, at least one sensor evaluation of at least one of the velocity and enveloped acceleration and current temperature level of the industrial rotating machine is initiated. The device going into an alarm mode when the machine evaluation meets a minimum threshold. Further, one of the at least one tri-color light emitting diodes illuminates red after the alarm mode is verified.

In another aspect of the present invention after waking up, at least one sensor evaluation of the at least one of the velocity and enveloped acceleration and current temperature level of the machine is initiated. The device then goes back into a sleep mode to conserve power when the machine evaluation does not meet a minimum threshold.

In another aspect of the present invention waking up a more frequent predetermined number of times after an alarm condition is verified.

In another aspect of the present invention one of the at least one tri-color light emitting diodes blinks red for one week after an alarm condition is verified.

In another aspect of the present invention a range in velocity of 10-1000 KHz is within one of the at least one the sensors range.

In another aspect of the present invention a machine rotational speed of 900-3600 rpm and maximum enveloped acceleration is 30 gE is within one of the at least one sensors range.

In another aspect of the present invention a stage 3 bearing defect can be detected prior to a catastrophic failure.

In another aspect of the present invention the at least one tri-color light emitting diode further comprises three translucent independently controlled light emitting diodes assembled on the upper top surface of the device.

In another aspect of the present invention the circuit board further comprises:

a band pass filter to filter the signal to eliminate low frequency structural machinery vibrations signals; and

a demodulator to demodulate and enhance the frequency content at a bearing defect frequency, and wherein

the band pass filter and demodulator act to improve the frequency response of the at least one acceleration sensor.

In another aspect of the present invention a bar code disposed on the warning device, and an inspection device having a bar code reader that is able to scan the device bar code to display the health status of the bearing.

In another aspect of the present invention the check point is one of a plurality of check points Cₙ on a predetermined route, and the bar code is one of a plurality of unique bar codes on a plurality of warning devices to be inspected, and the inspection provides an operator driven reliability that proves the plurality of warning devices have been checked by the operator.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 is an elevated perspective view of a warning device according to a preferred embodiment of the present invention;

FIG. 2 is a bottom side view of the warning device of FIG. 1, according to a preferred embodiment of the present invention;

FIG. 3 is a perspective view of the warning device of FIG. 1 with the body removed, according to a preferred embodiment of the present invention

FIG. 4 is a partial cross-sectional view in perspective of the warning device of FIG. 1 with the body removed, according to a preferred embodiment of the present invention;

FIG. 5 is a partial view of an inner bearing raceway having 3^{rd} order defects; and

FIG. 6 is a perspective view of an industrial environment showing multiple pieces of machinery configured with the warning device of FIG. 1 according to a preferred embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

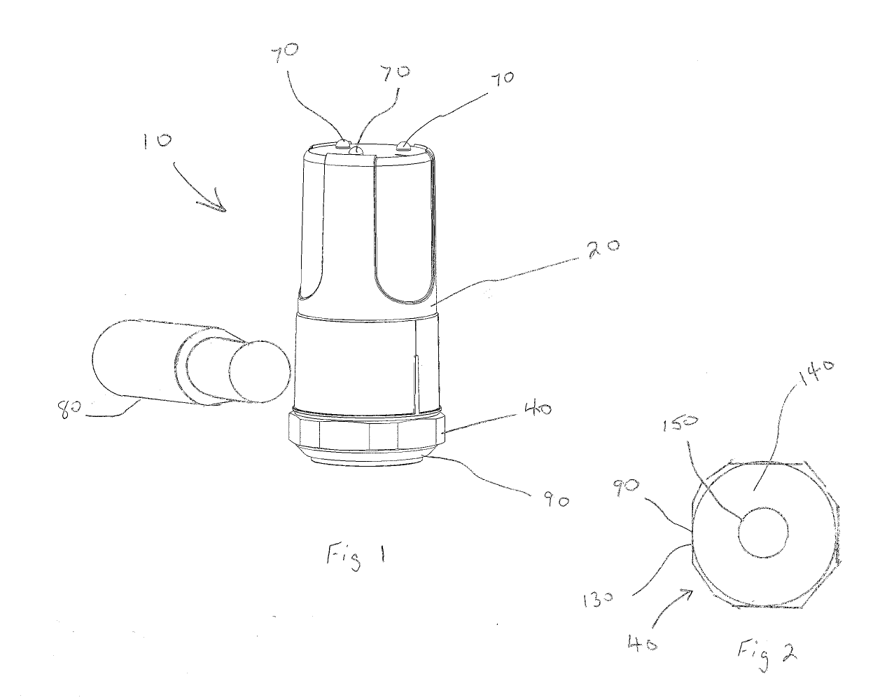

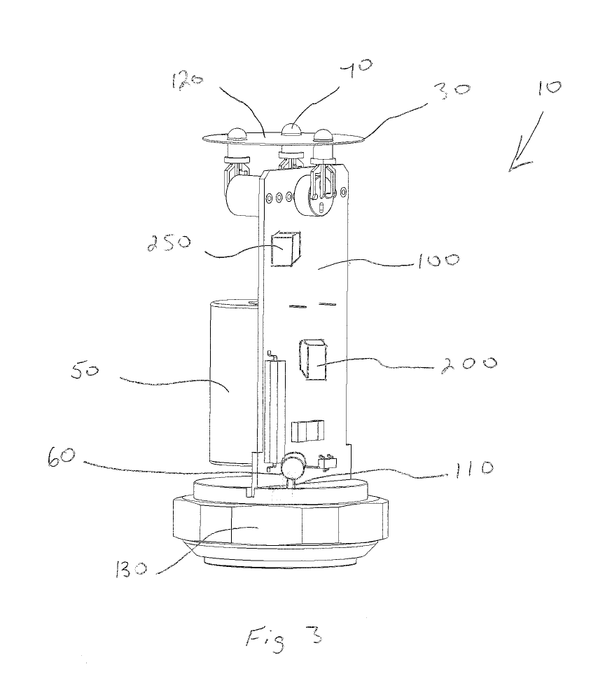

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

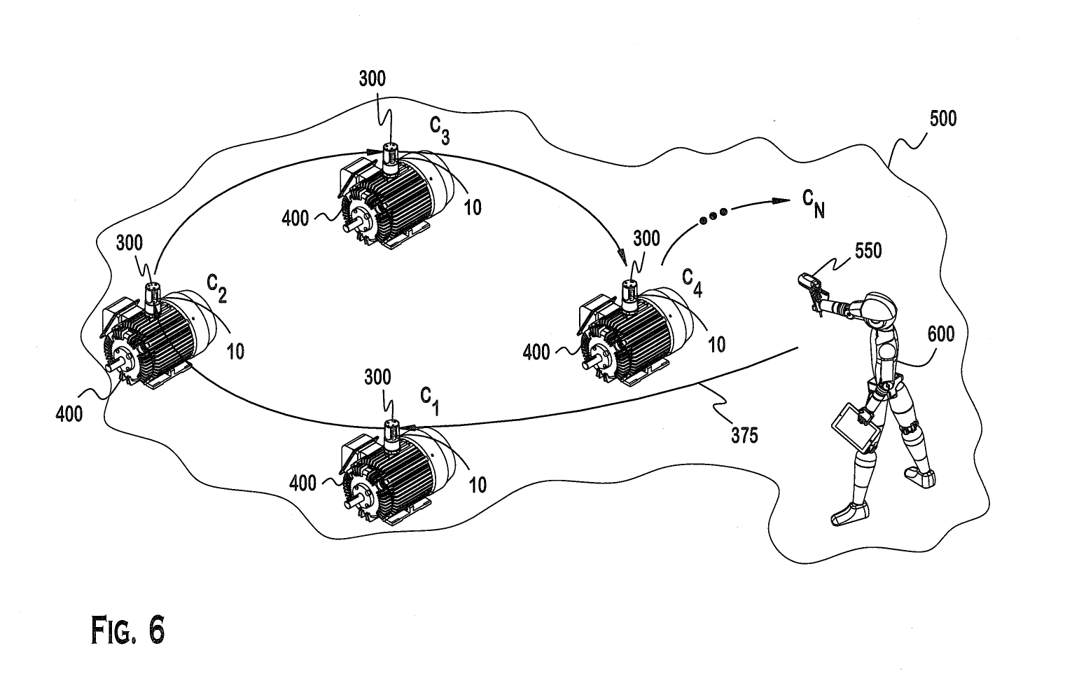

A warning device 10 for monitoring a health status of a bearing is illustrated in FIG. 1. The warning device is normally mounted to a piece of rotating industrial machinery 400 that is disposed in a manufacturing or operating environment 500. See FIG. 6 illustrating the warning device mounted to the machinery in the industrial environment. Typical applications for the warning device include motors, fans, conveyors and pumps.

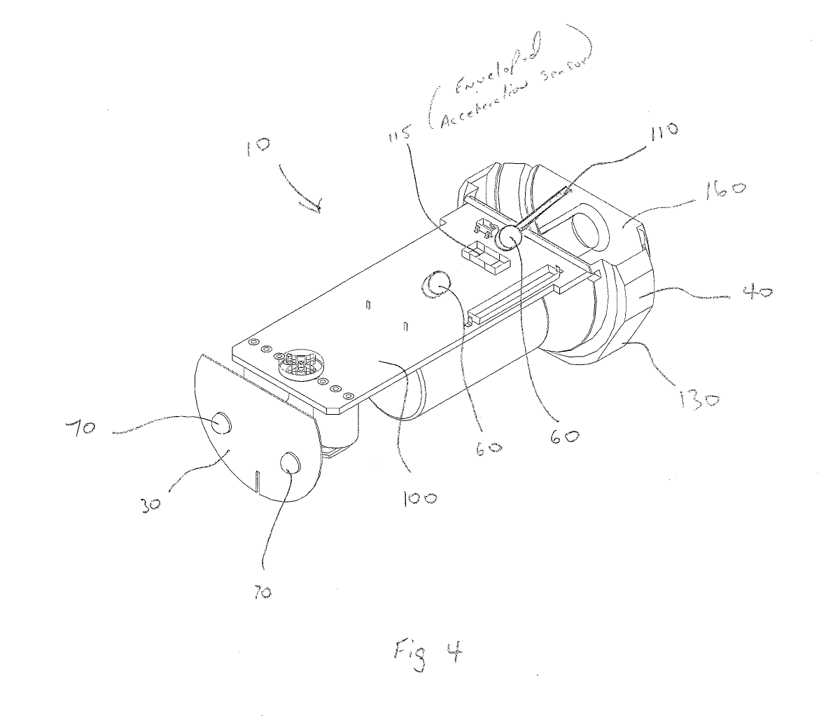

Referring back to FIG. 1, the warning device provides a generally cylindrical body portion 20 that is connected to an annular top portion 30. The annular top portion 30 includes at least one tri-color light emitting diode 70 (herein referred to as “LED”) for displaying the health status of the bearing. The at least one tri-color LED is mounted on an upper top surface 120 of the annular top portion 30 of the warning device for maximum visibility to a user. Referring to FIG. 3, the at least one tri-color LED may further provide three translucent light emitting diodes (70) assembled in parallel on an upper top surface (120) of the device.

Depending on the voltage applied to the at least tri-color LED 70, the LED may be configured to illuminate any one of red, green or translucent. Normally, the at least one tri-color LED functions to illuminate red or green. However, the LED used in the present invention is configured to illuminate translucent as well. In this case, the LED is energized to illuminate both red and green. The net affect of illuminating both red and green simultaneously, creates an amber illumination. The need for providing the three different colors will be disclosed in ensuing paragraphs. In an alternate embodiment, the at least one tri-color light emitting diode 70 may provide three light emitting diodes 70. The three light emitting diodes may be configured to illuminate red, green or translucent as well.

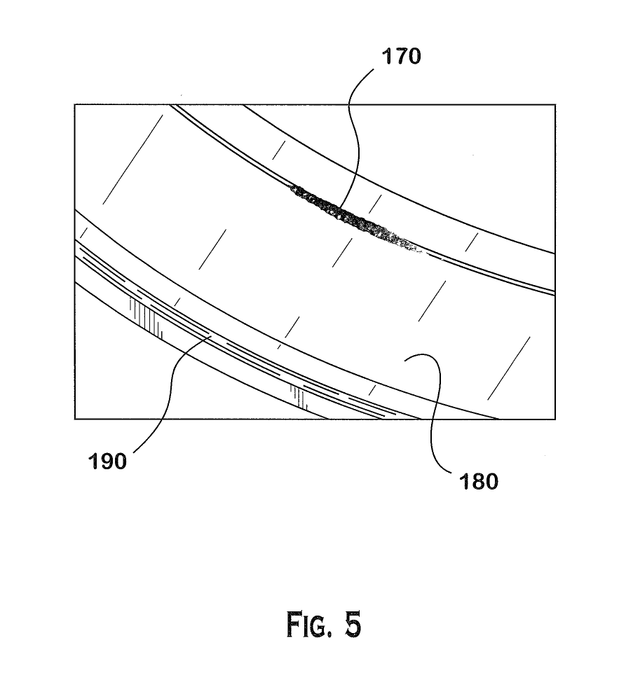

The warning device further provides at least one sensor 60 that senses at least one of a velocity, an enveloped acceleration and a temperature value of the bearing. Here, the at least one sensor 60 is mounted to a Printed Circuit Board 100 (PCB) (see FIG. 4), which is in tern potted inside the body 20 and base portion 40. One type of sensor employed may be a piezo-electric element that provides an acceleration signal, which is then processed to deliver the velocity and enveloped acceleration overall.

Consequently, the health status of the bearing is determined by input and feedback from one of the at least one sensors 60. The velocity relates to the whole machine which includes the shaft, bearing, coupling, footing, etc. The enveloped acceleration is designed to accentuate the bearing signal, but can pick up gear mesh too. Temperature is the bearing housing temp which relates to lubricant temperature, bearing temperature, and the fluid in a pump.

When a sensor senses a change in velocity or acceleration or temperature it sets off an alarm. In an alternate embodiment, the at least one sensor 60 may provide two temperature sensors 60 and an enveloped acceleration sensor (accelerometer) 115 for providing feedback. Velocity is calculated via the accelerometer 115. A range in velocity of 10-1000 KHz is within a normal sensing range. A range in machine rotational speed of 900-3600 rpm and maximum enveloped acceleration is 30 gE is within one of the at least one sensors 115 range.

The PCB as shown in FIG. 3 may include a band pass filter 200 to filter the signal and to eliminate low frequency structural machinery vibrations signals developed in the operating environment. The PCB may further include a demodulator (250) to demodulate and enhance the frequency content at a bearing defect frequency. Consequently, the band pass filter and demodulator act to improve the frequency response of the at least one acceleration sensor 115.

FIG. 4 shows the device having multiple temperature sensors 60. The warning device has at least one thermally conductive circuit board trace 110 that is integrally disposed within the mounting pad 90. The trace 110 is designed to conduct heat from the mounting pad 90 to one of the at least one sensors 60. This is one way the device obtains temperature feedback from a sensor.

Referring now to all the Figures, the warning device 10 also includes a base portion 40 that is connected to the body 20. The base portion 40 provides a mounting pad 90 that is integral to the base portion 40. The base portion 40 is used to mount the warning device 10 to the piece of rotating industrial machinery 400. The mounting pad 90 has a generally flat surface 140 for mounting to the machinery 400. The mounting pad (90) is hexagonal in shape and has at least two flat surfaces (130) for tightening the warning device with a tool (not shown).

The mounting pad 90 also has a threaded through hole 150 that allows a bolt (not shown) to be threaded into. Typically, the bolt runs up through a clearance hole drilled in the machinery 400 and into the threaded through hole 150, thus securing the device 10. It should be noted that there are many other potential configurations for mounting the warning device that can be contemplated by one skilled in the art. For example, the warning device could be fixedly epoxied to the rotating machinery.

The warning device 10 further includes a battery 50 for powering the device 10. The battery can be a lithium battery rated for long life. Lithium batteries are disposable (primary) batteries that have lithium metal or lithium compounds as an anode. The battery is usually sealed in epoxy. As such, battery replacement is not possible. The battery (50) provides power to the device 10 for at least 3 years of normal operation. This is conditional on the device seeing a single alarm detection. Battery life decreases proportionally with the number of alarm detections. Consequently, one can expect two years of life with two alarm detections and one year of life after three alarm detections. The warning device must be manually reset after it detects an alarm condition. Therefore, if battery life permits, the warning device can be reset up to three times before replacement is required.

The warning device 10 is synchronized to a magnetic coded key (80). One of the at least one tri-color LED's blinks red for 10 seconds after the magnetic key is read. When the magnetic coded key 80 is applied next to the device 10 the device becomes activated. After the magnetic key is applied 80, the device 10 initiates a self check mode to verify its proper function. In operation, one of the at least one tri-color LED's 70 illuminates green when the device 10 passes its self check mode. Alternately, one of the at least one LED's 70 illuminates amber when the device fails its self check mode.

The device 10 is programmed to wake up a predetermined number of times over a 24 hour period in order to check if the industrial machine is in operation. Normally, the device wakes up 8 times per day, but this can be changed to meet a customers requirements. After waking up, at least one sensor evaluation of at least one of the velocity and enveloped acceleration and current temperature level of the industrial rotating machine is initiated. When the machine evaluation meets a minimum threshold, the device goes into an alarm mode. Further, one of the at least one tri-color light emitting diodes illuminates red after the alarm mode is verified.

Alternately, when the machine evaluation does not meet a minimum threshold after waking up and the sensor evaluation is initiated, the device goes back into a sleep mode to conserve power. The device wakes up a more frequent predetermined number of times after an alarm condition is verified. As such, one of the at least one tri-color light emitting diodes blinks red for one week after an alarm condition is verified.

A stage 3 bearing defect is illustrated in FIG. 5. The warning device of the present invention can detect a stage 3 bearing defect 150 prior to a catastrophic failure. FIG. 5 shows a bearing raceway 190 having an inner surface 180 and stage 3 sidebanding defects 170. In the third stage of failure, bearing defect frequency levels increase and their harmonics appear on the spectrum. As wear progresses, sidebanding increases around the defect frequencies and can be seen more clearly as raised levels and harmonics in the mounted resonance area.

FIG. 6 illustrates an operator 600 pointing an inspection device 550 at a bar code disposed 300 that is disposed on the warning device in the operating environment 500. The inspection device 550 having a bar code reader that is able to scan the bar code 300 at a series check points C₁, C₂, C₃ and C₄. The check points C₁-C₄ may further provide of a plurality of check points Cₙ on a predetermined route 375 and the bar code 300 is one of a plurality of bar codes 300 on a plurality of warning devices 10 to be inspected. By making the operator conduct the inspection and record the status of each device, an operator driven reliability that proves the plurality of warning devices have been checked by the operator is generated.

1. A warning device and for monitoring a health status of a bearing mounted to a piece of rotating machinery in an industrial environment, the warning device comprising:
a generally cylindrical body portion;
an annular top portion;
a base portion;
a battery for powering the device;
at least one sensor that senses at least one of a velocity, an enveloped acceleration and a temperature value of the bearing;
at least one tri-color light emitting diode for displaying the health status of the bearing according to input from one of the at least one sensors;
a mounting pad integral to the base portion for mounting the warning device to the piece of rotating industrial machinery;
a circuit board disposed within the body; and
at least one thermally conductive circuit board trace integrally disposed within the mounting pad, the trace to conduct heat from the mounting pad to one of the at least one sensors, and wherein
the one of the at least one sensors being mounted on the circuit board; and wherein
the device initiates a self check mode to verify its proper function after the warning device has been activated.

2. The warning device for monitoring the health status of a bearing according to claim 1, wherein the at least one sensor further comprises two temperature sensors and an acceleration sensor, the acceleration sensor being a piezo-element that provides an acceleration signal, which is then processed to deliver the velocity and enveloped acceleration overall.

3. The warning device for monitoring a health status of a bearing according to claim 1, wherein the battery provides power to the device for at least 3 years of normal operation with a single alarm detection.

4. The warning device for monitoring a health status of a bearing according to claim 1, wherein the mounting pad is hexagonal in shape and has at least two flat surfaces for tightening the warning device with a tool.

5. The warning device for monitoring a health status of a bearing according to claim 1, wherein the at least one tri-color light emitting diode is mounted on an upper top surface of the warning device for maximum visibility to a user.

6. The warning device for monitoring a health status of a bearing according to claim 1, wherein one of the at least one tri-color light emitting diode illuminates green when the device passes its self check mode.

7. The warning device for monitoring a health status of a bearing according to claim 1, wherein one of the at least one light emitting diodes illuminates amber when the device fails the self check mode.

8. The warning device for monitoring a health status of a bearing according to claim 1, wherein the device wakes up a predetermined number of times over a 24 hour period in order to check if the industrial machine is in operation.

9. The warning device for monitoring a health status of a bearing according to claim 8, wherein after waking up, at least one sensor evaluation of at least one of the velocity and enveloped acceleration and current temperature level of the industrial rotating machine is initiated, and wherein
the device goes into an alarm mode when the machine evaluation meets a minimum threshold, and wherein
one of the at least one tri-color light emitting diodes illuminates red after the alarm mode is verified.

10. The warning device for monitoring a health status of a bearing according to claim 8, further comprising after waking up, at least one sensor evaluation of the at least one of the velocity and enveloped acceleration and current level of the machine is initiated, and wherein
the device goes back into a sleep mode to conserve power when the machine evaluation does not meet a minimum threshold.

11. The warning device for monitoring a health status of a bearing according to claim 9, further comprising waking up a more frequent predetermined number of times after an alarm condition is verified.

12. The warning device for monitoring a health status of a bearing according to claim 9, wherein one of the at least one tri-color light emitting diodes blinks red for one week after an alarm condition is verified.

13. The warning device for monitoring a health status of a bearing according to claim 1, wherein one of the at least one tri-color light emitting diodes blinks red for 10 seconds after a magnetic key is applied to and read by the warning device.

14. The warning device for monitoring a health status of a bearing according to claim 1, wherein a range in velocity of 10-1000 KHz is within one of the at least one the sensors sensing range.

15. The warning device for monitoring a health status of a bearing according to claim 1, wherein a range in machine rotational speed of 900-3600 rpm and maximum enveloped acceleration is 30 gE is within one of the at least one sensors sensing range.

16. The warning device for monitoring a health status of a bearing according to claim 1, wherein a stage 3 bearing defect can be detected prior to a catastrophic failure.

17. The warning device for monitoring a health status of a bearing according to claim 1, wherein the acceleration sensor is a piezo-element that provides an acceleration signal, processed to deliver the velocity and enveloped acceleration.

18. The warning device for monitoring a health status of a bearing according to claim 5, wherein the at least one tri-color light emitting diode further comprises three independently controlled translucent light emitting diodes assembled on the upper top surface of the device.

19. The warning device for monitoring a health status of a bearing according to claim 1, wherein the circuit board further comprises:
a band pass filter to filter the signal to eliminate low frequency structural machinery vibrations signals; and
a demodulator to demodulate and enhance the frequency content at a bearing defect frequency, and wherein
the band pass filter and demodulator act to improve the frequency response of the at least one acceleration sensor.

20. The warning device for monitoring a health status of a bearing according to claim 1, further comprising a bar code disposed on the warning device, and an inspection device having a bar code reader that is able to scan a bar code disposed on the device to display the health status of the bearing at a plurality of check points C.

21. The warning device for monitoring a health status of a bearing according to claim 19, wherein the check point is one of a plurality of check points Cₙ on a predetermined route, and the bar code is one of a plurality of bar codes on a plurality of warning devices to be inspected, and wherein
the inspection provides an operator driven reliability that proves the plurality of warning devices have been checked by the operator.
